(19) United States
(12) Patent Application Publication
(10) Pub. No.: US 2015/0024687 A1
(43) Pub. Date: Jan. 22, 2015

(54) SYSTEMS AND METHODS FOR COEXISTENCE BETWEEN MULTIPLE WIRELESS NETWORKS

(71) Applicant: QUALCOMM Incorporated, San Diego, CA (US)

(72) Inventors: Abhishek RAWAT, Fremont, CA (US); Eric Yuchuen TSOU, Palo Alto, CA (US); Jibing WANG, San Diego, CA (US); Ductuan Do NGUYEN, San Jose, CA (US)

(73) Assignee: QUALCOMM Incorporated, San Diego, CA (US)

(21) Appl. No.: 13/947,769

(22) Filed: Jul. 22, 2013

(51) Int. Cl. H04W 88/06; H04W 4/00

(52) U.S. Cl. CPC H04W 88/06; H04W 4/008
USPC 455/41.2

(57) ABSTRACT

Use is made of the Notice-of-Absence (NoA), as is a Wi-Fi/Bluetooth time sharing mechanism. This mechanism dictates ‘n’ cycles of absent and present duration of P2P-GO starting at a defined time ‘t’. The information bits of NoA are communicated from GO to the Client in the Beacons (for the period of NoA in use). Time-sharing between Bluetooth and WLAN at P2P-GO, is communicated using NoA to the P2P-Client. For the duration of both Bluetooth and WLAN radios transmitting/receiving traffic, NoA is used such that the absent duration covers the Bluetooth Interval and present-duration covers the WLAN interval. This NoA remains effective for as long as the time-sharing mode between BT and WLAN radios. As soon as, P2P-GO enters the time-sharing mode, NoA parameters are determined based on the timesharing mode (Dynamic Long and Dynamic Short). The start time of NoA schedule is determined after synchronizing to the time-sharing scheduler. The start time of NoA schedule is ‘n’ TBTTs after entering the time-sharing mode so that the Clients have ample opportunity to receive the NoA information. Until NoA schedule starts, P2P-GO may protect Bluetooth Interval using CTS2S frames. After NoA schedule comes into play, P2P-GO may send CTS2S only for asynchronous Bluetooth traffic.

### FIELD OF THE PRESENT DISCLOSURE

The present disclosure generally relates to wireless communications and more particularly relates to systems and methods for operation between multiple wireless networks to minimize interference.

### BACKGROUND

Wireless networks are increasingly employed to provide various communication functions including voice, video, packet data, messaging and the like. Further, multiple wireless networks may be employed by a single device to obtain the relative performance benefits offered by each wireless communication system in different usage scenarios. For example, wireless local area networks (WLANs) conforming to 802.11 standards established by The Institute of Electrical and Electronics Engineers may be used for applications involving communication over medium ranges while the BLUETOOTH® (Bluetooth) system may be used for relatively shorter range communications.

To that end, Bluetooth is often used to connect and exchange information between mobile phones, computers, digital cameras, wireless headsets, speakers, keyboards, mice or other input peripherals, and similar devices. Bluetooth allows for the creation of a personal area network (PAN) between a master and up to seven slaves. For many Bluetooth applications, it is necessary to ensure the uninterrupted delivery of correctly ordered data packets. On the other hand, WLAN communications provide relatively high data rates over relatively long distances, offering an easy interface to existing network infrastructures. As such, the nature of a significant portion of WLAN traffic makes it less susceptible to packet order and delivery time problems.

Although WLAN communications operate on an asynchronous protocol and access the wireless medium using Carrier Sense Multiple Access/Collision Avoidance (CSMA/CA) mechanisms while Bluetooth communications rely on time division multiplex access (TDMA) mechanisms, both share the 2.4 GHz Industrial Scientific and Medical Device band (ISM) band. As a result, interference between the two communications systems may occur. This problem is exacerbated by the physical collocation of the systems when both are implemented in a single device. Indeed, current trends are moving from each system being carried on separate integrated circuits to merging both onto a single chip in system on a chip (SoC) designs. Further, given the difference in the typical nature of the WLAN and Bluetooth communications, certain Bluetooth links need to be given priority in order to guarantee the necessary quality of service.

Recognizing the potential for interference, various techniques have been employed to improve coexistence. One conventional strategy relies on the frequency hopping aspects of the Bluetooth devices. The WLAN communication tend to park, having a center at one frequency and width within the spectrum while the Bluetooth devices “hop” around, transmitting or receiving over 625 μs time slots on one of the 79 available 1 MHz bands before switching to another channel. Once interference is detected, adaptive frequency hopping (AFH) techniques allow the Bluetooth devices to avoid the Bluetooth channels that overlap the WLAN channel.

Although AFH offers significant performance gains, the out-of-band Bluetooth signal can still affect WLAN signals, especially when the systems are collocated. Typically, the WLAN system receives packets from a relatively more distant access point, increasing the chance that the WLAN front end will be saturated by the Bluetooth transmissions. To address the potential for interference between WLAN and Bluetooth systems, time division multiplexing (TDM) arbitration schemes may be employed to schedule transmissions to prevent or minimize simultaneous operation in order to share the time spent using the 2.4 GHz band by the respective systems.

In order to enforce the scheduling decisions made by the arbitration scheme, a communications device may be configured to suppress transmissions from other WLAN devices on the network during times allocated to the Bluetooth system. For example, conventional techniques for achieving this result may involve sending Clear to Send to Self (CTS2S) frames. Specifically, the CTS2S frame contains a Network Allocation Vector (NAV) corresponding to a given time period during which any devices on the network receiving the frame will suspend transmissions. As such, these frames are typically used to reserve the WLAN medium so that the device sending the frame may then transmit subsequent frames without causing collisions.

In the context of Bluetooth coexistence, however, the CTS2S frame has the effect of suppressing WLAN transmissions from other devices on the network to prevent interference with the Bluetooth system. Although the CTS2S mechanism is effective, it has drawbacks in that all devices receiving the frame suspend transmission, even if their activity would not impact the Bluetooth system of the device sending the frame. Further, the use of the CTS2S mechanism by one device may prevent other devices from affecting their own coexistence procedures, since the CTS2S frame will impact any device in range.

Accordingly, what has been needed are systems and methods for implementing WLAN and Bluetooth communications that minimize interference. For example, there is a need to provide a system and method that are configured to protect downlink WLAN traffic while still ensuring a quality of service necessary for Bluetooth communications. This disclosure is directed to these and other need.

### SUMMARY

This disclosure is directed to systems and methods for coordinating time of transmission between networks' nodes. In one aspect, the disclosed systems and methods implement a Bluetooth coexistence strategy in the context of a device functioning as a group owner (GO) in a Wi-Fi Direct, peer-to-peer (P2P) network communication with a P2P client. This embodiment uses the notice of absence (NoA) function of the Wi-Fi Direct protocol to coordinate periods of time during which the device will be treated as absent by the client, so that the client does not transmit during periods of Bluetooth activity. Likewise, the NoA also coordinates periods during which the device will be treated as present by the client, to maintain a desired level of WLAN performance.

The NoA is an information element (IE) that is transmitted during a beacon frame by the GO. The NoA specifies a start time, an absent duration beginning at the specified start time, an interval duration that includes the absent duration and the present duration, and a number of cycles for which to implement the schedule. As such, the NoA IE may be sent in a beacon by the GO after determination of the formation of a Bluetooth link, such as an advanced audio distribution profile (A2DP) link. The NoA parameters may be established so that the absent and present cycle established between the GO and the peer coincides with the time scheduling of the Bluetooth link.

As desired, the beacon containing the NoA IE with the parameters corresponding to the Bluetooth link may be sent in the next beacon after establishment of the link or may be sent as a subsequent beacon. Further, the NoA IE may specify a start time that occurs within the immediately succeeding beacon interval or may be delayed by one or more target beacon transmission time instants (TBTT's) to allow the client sufficient time to receive and implement the NoA parameters. Further, it may also be desirable to adjust one or more parameters of the NoA IE to provide a buffer period on either or both sides of the Bluetooth window.

By employing the techniques disclosed herein, coexistence between the Bluetooth system and WLAN system may be achieved in a non-disruptive manner that presents a minimal impact on the WLAN medium. Further, protecting the Bluetooth link allows the desired audio quality metric of the system to be achieved. Power efficiency is also improved, by allowing the client to go into a power save mode during the absent periods coordinated by the NoA and by reducing the number of CTS2S frames sent by the GO. Reducing the overhead associated with CTS2S frames also increases the WLAN bandwidth. Yet another benefit is that multiple GO entities employing this scheme may operate in near-range while still achieving Bluetooth audio-quality and WLAN-throughput metrics.

### BRIEF DESCRIPTION OF THE DRAWINGS

The aforementioned objects and advantages of the disclosed systems and methods, as well as additional objects and advantages thereof, will be more fully understood herein after as a result of a detailed description of an embodiment when taken in conjunction with the following drawings in which:

FIG. 1 depicts a peer-to-peer wireless communication system, according to an embodiment;

FIG. 2 schematically depicts functional blocks of a peer communications device;

FIG. 3 depicts an embodiment with regard to an A2DP Bluetooth communications link and NoA coordination between a GO and a client including use of CTS2S frames to augment the NoA IE beacon; and

FIG. 4 is a flow chart representation of a method disclosed herein.

### DETAILED DESCRIPTION

At the outset, it is to be understood that this disclosure is not limited to particularly exemplified materials, architectures, routines, methods or structures as such may, of course, vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

Some portions of the detailed descriptions which follow are presented in terms of procedures, logic blocks, processing and other symbolic representations of operations on data bits within a computer or processor memory. These descriptions and representations are the means used by those skilled in the data processing arts to most effectively convey the substance of their work to others skilled in the art. In the present application, a procedure, logic block, process, or the like, is conceived to a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, and throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of process-executable instructions residing on some form of processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits and steps are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope hereof Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “process,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computer devices, e.g., a combination of DSP and a microprocessor, a plurality of microprocessors, one or more microprocessors in conjunction with a DSP core, or any other such configuration.

For purposes of convenience and clarity only, directional terms, such as top, bottom, left, right, up, down, over, above, below, beneath, rear, back, and front, may be used with respect to the accompanying drawings or particular embodiments. These and similar directional terms should not be construed to limit the scope hereof in any manner and may change depending upon context. Further, sequential terms such as first and second may be used to distinguish similar elements, but may be used in other orders or may change also depending upon context.

Unless define otherwise, all technical and scientific terms used herein have the same meaning as commonly understood by one having ordinary skill in the art to which the disclosure pertains.

Finally, as used in this specification and the appended claims, the singular forms “a,” “an” and “the” include plural forms as well unless the content clearly dictates otherwise.

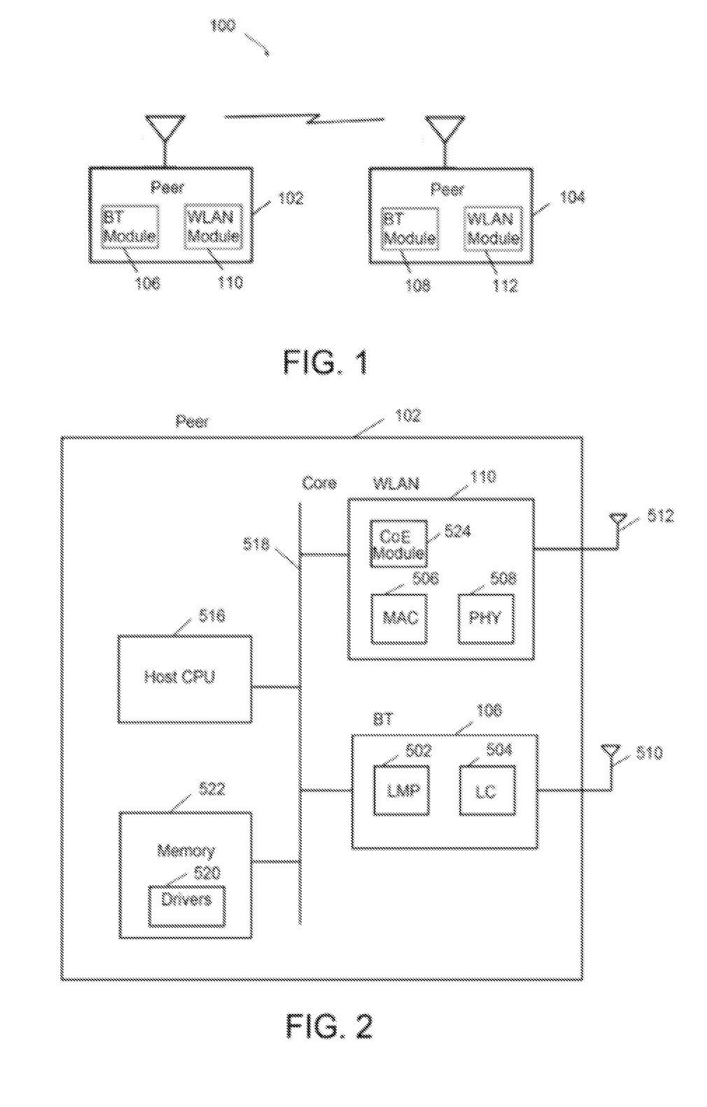

These systems and methods are described in reference to an exemplary wireless communication system 100 as shown in FIG. 1, which fundamentally includes at least two nodes, peer 102 and peer 104. In this embodiment, peer 102 and peer 104 each have Bluetooth (BT) modules 106 and 108, respectively, and WLAN modules 110 and 112, respectively. The Bluetooth specification allows for the creation of a personal area network (PAN) between a master and up to seven slaves and is often used to connect and exchange information between mobile phones, computers, digital cameras, wireless headsets, speakers, keyboards, mice or other input peripherals, and similar devices. Conventional Bluetooth communications employ a dedicated physical layer as indicated by Bluetooth modules 106 and 108 using a frequency-hopping spread spectrum technique. Further, WLAN module 110 of peer 102 and WLAN module 112 of peer 104 may communicate using another suitable peer-to-peer protocol, such as Wi-Fi Direct. For example, peer 102 may function in the role of a Wi-Fi Direct Peer-to-Peer (P2P) Group Owner (GO) and peer 104 may function in the role of a Wi-Fi Direct P2P Client.

Some embodiments implement a Bluetooth coexistence strategy in the context of a device functioning as a group owner (GO) in a Wi-Fi Direct, peer-to-peer (P2P) network communication with a P2P client. For Bluetooth communications, this strategy uses the notice of absence (NoA) function of the Wi-Fi Direct protocol to coordinate periods of time during which the device will be treated as absent by the client, so that the client does not transmit during periods having Bluetooth activity. Likewise, the NoA also coordinates periods during which the device will be treated as present by the client, to maintain a desired level of WLAN performance.

The NoA is an information element (IE) that is transmitted during a beacon frame by the GO. The NoA specifies a start time, an absent duration beginning at the specified start time, an interval duration that includes the absent duration and the present duration, and a number of cycles for which to implement the schedule. As such, the NoA IE may be sent in a beacon by the GO after determination of the formation of a Bluetooth link having a defined periodicity, such as an advanced audio distribution profile (A2DP) link. The NoA parameters may be established so that the absent and present cycle established between the GO and the peer coincides with the time scheduling of the Bluetooth link.

FIG. 2 is a high level schematic diagram of the principal functional blocks of peer 102. Generally, peer 102 may employ an architecture in which the lower levels of the respective protocol stacks of Bluetooth module 106 and WLAN module 110 are implemented in firmware and hardware modules, including Bluetooth module 106 and WLAN module 110. Bluetooth module 106 includes Link Manager Protocol (LMP) 502 for managing the Bluetooth radio frequency link between peer 102 and peer 104 by performing advertisement, scanning, connection and security functions. Bluetooth module 106 also includes Link Controller (LC) 504 for performing the hardware-specific transmission and reception of electronic signals. Likewise, WLAN module 110 includes media access controller (MAC) 506 that performs functions related to the handling and processing of frames of data including verification, acknowledgement, routing, formatting and the like. Incoming and outgoing frames are exchanged between MAC 506 and physical layer (PHY) 508, which as shown here includes the functions of modulating the frames according to the relevant 802.11 protocol as well as providing the analog processing and RF conversion necessary to provide transmission and reception of wireless signals.

As shown, Bluetooth module 106 and WLAN module 110 each have an associated antenna, antennas 510 and 512, respectively. As desired, one or more antennas may be shared between the modules using switching techniques known in the art. In some embodiments, Bluetooth module 106 and WLAN module 110 may be collocated on a common system, e.g., on the same circuit board or on distinct circuit boards within the same system, or may be embedded on the same integrated circuit as in a system on a chip (SoC) implementation.

Peer 102 also includes host CPU 516 configured to perform the various computations and operations involved with the functioning of peer 102. Host CPU 516 is coupled to Bluetooth module 106 and WLAN module 110 through bus 518, which may be implemented as a peripheral component interconnect express (PCIe) bus, a universal serial bus (USB), a universal asynchronous receiver/transmitter (UART) serial bus, a suitable advanced microcontroller bus architecture (AMBA) interface, a serial digital input output (SDIO) bus, or other equivalent interface. Upper layers of the protocol stacks of the Bluetooth and WLAN systems are generally implemented in software as Drivers 520 stored in memory 522 that may be accessed by host CPU 516 over bus 518.

As shown, WLAN module 110 also includes co-existence (CoE) module 524 that may be implemented as processor readable instructions stored in firmware and operable by WLAN module 110 as shown. Co-existence module 524 may be configured to perform steps associated with the algorithm described herein below. In other embodiments, co-existence module 524 may be implemented in software or hardware at any suitable location within peer 104.

Operations of peer 102 in the network connection with peer 104 may include the periodic transmission of a management frame known as a beacon. Although discussed in the context of peer 102, it will be appreciated that peer 104 may also transmit a beacon frame and these techniques may also be extended to peer 104 as applicable. Further, these techniques may also be applied to other network architectures having analogous aspects. In one example, a device configured to function as a software-enabled access point (softAP) may be considered to operate in a manner similar to the other peer-to-peer architectures disclosed herein, since this configuration involves direct communication between the softAP and an associated device. As such, peer 102 may also be a device acting in a softAP role while peer 104 may be a station associated with the softAP. To the extent that IEEE 802.11 protocols may dictate certain operational characteristics for a device acting in a softAP role that conflict with aspects of this disclosure, such as a requirement for the continuous transmission of periodic beacons, a softAP functioning as peer 102 may constitute a proprietary solution.

The beacon frame is used to communicate parameters regarding operation of the peer-to-peer communication, including identification information, supported rates, timing information and the like. The time interval between the start of two consecutive beacons is called a beacon interval and may be used to establish a target beacon transmit time (TBTT). The beacon interval may be fixed or variable and may be set to a suitable duration, e.g., 100 msec.

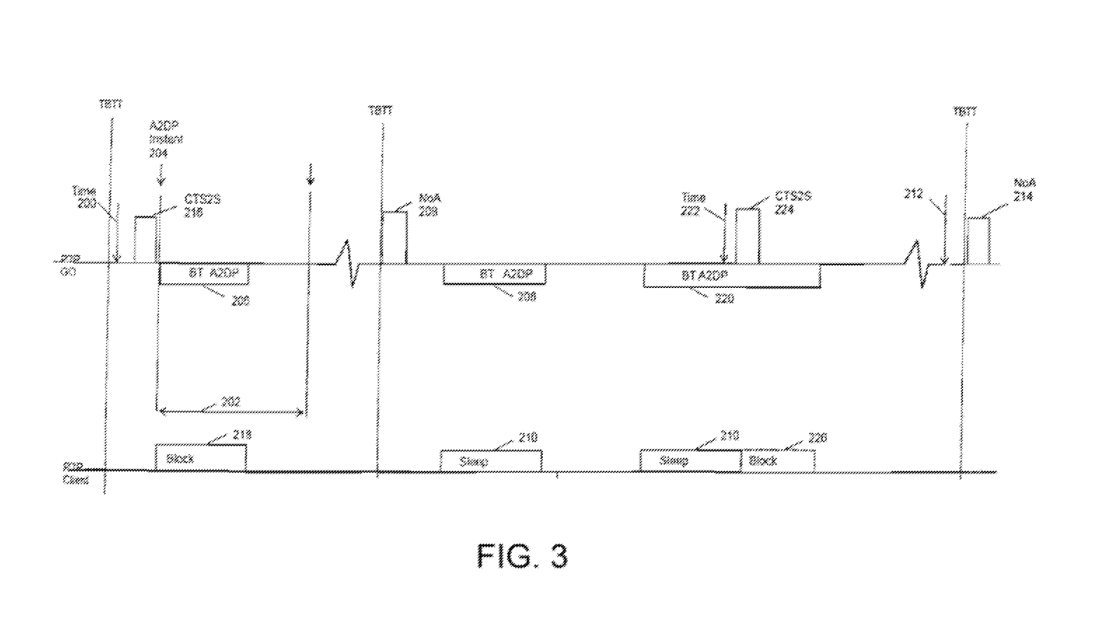

A typical time-based graph exemplary of this implementation is shown in FIG. 3.

With regard to an Advance Audio Distribution Profile (A2DP) Bluetooth communications link and NoA coordination between a GO and client, the GO sends beacon frames at regular intervals, as indicated by the target beacon transmission time (TBTT) instants. Upon the establishment of the A2DP link at time 200, GO may determine characteristics of the A2DP link and set parameters for the NoA accordingly. As will be appreciated, the A2DP link may involve A2DP interval 202 starting at A2DP instant 204 that may include A2DP window 206. In one example, the A2DP instant may be offset from the TBTT by 20 time units, the A2DP window may be 60 time units and the A2DP interval may be 100 time units. Accordingly, during the next beacon, the GO includes a NoA IE 208 that specifies a start time corresponding to the A2DP instant, an absent duration of 60 time units to correspond to the A2DP window and an interval of 100 time units to correspond to the A2DP interval. Further the count value may be set to a desired period of time or may be set to the 255 which signals the client to adopt the NoA scheduling indefinitely.

Therefore, while the A2DP link remains active, the client will treat the GO as absent during the A2DP window and will not transmit to the GO during the sleep periods 210 established by the NoA IE. Once the A2DP link is disconnected at time 212, the GO may include a NoA IE 214 in the next beacon to discontinue the cycle.

Since the sleep periods will not be enabled at the client until the beacon with NoA ID 208 is sent, it may be desirable to protect the A2DP link prior to that time using CTS2S. For example, CTS2S 216 may be sent to block transmissions from the peer for a period of time 218 sufficient to cover the A2DP window. Furthermore, under an A2DP link, the A2DP window may be extended as necessary to maintain the desired throughput. As such, the absent periods established by NoA IE 208 may not cover an A2DP window that is extended. Therefore, GO may be configured to monitor Bluetooth activity to determine whether adjustments to the client's schedule are necessary. As shown, after the GO determines the existence of an extended A2DP window 220 at time 222, it may be configured to transmit CTS2S to block transmissions from the peer for a period of time 226 sufficient to cover the extended A2DP window.

### Adaptive NoA for Wi-Fi Direct Coexistence with Asynchronous Bluetooth-ACL Traffic

For Bluetooth audio streaming scenario, the time-sharing mechanism needs to meet the duty cycle needs of Bluetooth Traffic such that the Quality of Service for Bluetooth is met (no audio anomalies).

During such time-sharing mechanism, there are no fixed slots for Bluetooth and the scheduler allows Bluetooth to go up to a maximum window while it dynamically assesses Bluetooth traffic.

For NoA based time-sharing mechanism, the objective is to change NoA for covering the dynamic Bluetooth grants using NoA's absent period.

The algorithm for accomplishing such coexistence may by way of example be:

Definitions:

W_{LAN-DEF-MAX}: Default Maximum WLAN Window

W_{BT-DEF-MAX}: Default Maximum Bluetooth Window

T_{sub-window}: Window size for Bluetooth Extension

n: maximum number of Bluetooth Extensions such that (n* T_{sub-window}−W_{BT-DEF-MAX})

T_{EXT-INCR}: Time since the last change in NoA after which an increase in Bluetooth Max window (W_{BT-DEF-MAX}) OR the new absent period (NoA parameter) would be considered.

T_{EXT-DECR}: Time since the last change in NoA after which a decrease in Bluetooth Max window (W_{EBT-DEF-MAX}) OR the new absent period (NoA parameter) would be considered.

Algorithm:

i) Assign a default duty cycle percentage to initialize time-sharing. This translates into WLAN-Default-Window (W_{WLAN-DEF-MAX}), BT-Default-Max-Window (W_{BT-DEF-MAX}). Set the NoA (Periodic) parameters based on these Default time sharing parameters.

ii) After the NoA (Periodic) schedule starts, sample BT traffic requirements:
a. During BT grant/window—after every T_{sub-window} milliseconds (n*T_{sub-window}=W_{BT-}_{DEF-MAX}) check if BT has more traffic.
   i. If yes, add T_{sub-window} to BT-sample-size. Otherwise store the BT-sample-size.
   ii. If BT still has more traffic at the end of BT grant/window—then add T_{sub-window} to the W_{BT-DEF-MAX} and store the sample size.

iii) Re-evaluate BT sample size and dynamically change the NoA Parameters.
a. After every T_{EXT-INCR} duration (400 milliseconds) since the last NoA change-if BT sample size indicates an increase in BT window, then increase BT window/absent period by T_{sub-window}. Calculate new values for NoA parameters (absent period, startTsf, present period (same as earlier)).
b. After every T_{EXT-DECR} duration (1000 milliseconds) since the last NoA change-if BT sample size indicates a decrease in BT window, then decrease BT window/absent period. Calculate New values for NoA parameters (absent period, startTsf, present period (same as earlier)).
c. The values of T_{EXT-INCR} and T_{EXT-DECK} are different so that the scheduler is aggressive in increasing maximum grant-size for Bluetooth (W_{BT-DEF-MAX}) and conservative in decreasing maximum grant-size for Bluetooth (W_{BT-DEF-MAX}). This also applies a hysteresis to the change in Bluetooth maximum grant-size (W_{BT- DEF-MAX}).

iv) Apply the new NoA parameters calculated to meet the changed demand of Bluetooth traffic. Change W_{BT-DEF- MAX} to the new value.

For comparison between the BT window stored sample size and the W_{BT-DEF-MAX}
a. If the second highest value (to screen out the random blips in the sample) from the sampled BT window size is less or greater than BT-Default-Max-Window (W_{BT-DEF-MAX}) then decrease or increase the BT window size by T_{sub-window} respectively.

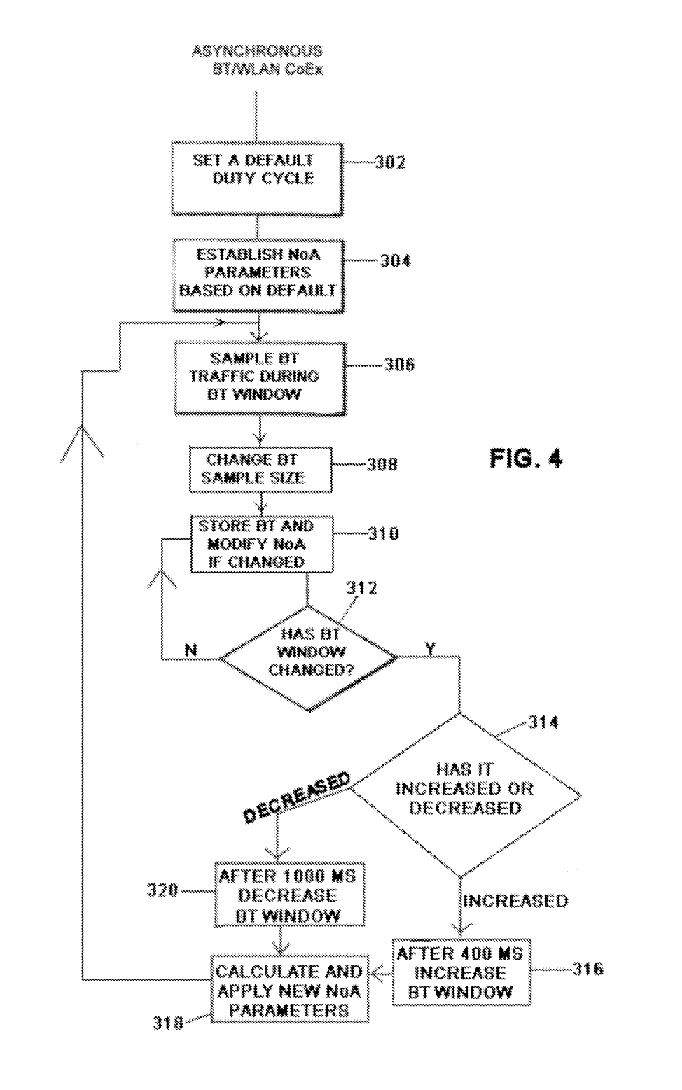

The principal features of the algorithm disclosed herein are depicted in flow chart format in FIG. 4. Co-existence time sharing may commence by setting a default duty cycle in 302 which is followed by establishing corresponding NoA parameters in 304. BT traffic is then sampled in 306 and changed if necessary in 308. In 310, the new BT-sample size is stored and if change, NoA parameters are modified accordingly. In 312, a BT-conservative window modification is commenced by ascertaining in 314 whether BT window has been increased or decreased. If it has been increased, the BT window/absent period is increased after only 400 milliseconds in 316. If it has been decreased, the BT window/absent period is decreased after 1000 milliseconds in 320. NoA is then appropriately modified in 318.

It will therefore now be understood that the disclosed systems and methods advantageously provide:
i) Non-disruptive approach of communicating coexistence time-sharing (hence period of unavailable WLAN access to medium)) from P2P-GO to Client.
ii) Obviating the existing need for P2P-GO to transmit CTS2S for every Bluetooth Interval protection hence, saving power.
iii) Potential to achieve higher throughput for WLAN as overhead to transmit CTS2S is obviated.

Thus, it will be observed that by use of the NoA mechanism for P2P-GO and BT coexistence allows:
i) Multiple GO entities employing this mechanism can operate in near-range and achieve Bluetooth Audio-quality and WLAN-throughput metric.
ii) This allows a non-disruptive approach promoting BT-WLAN coexistence.

Described herein are presently preferred embodiments. However, one skilled in the art that pertains to the present embodiments will understand that the principles of this disclosure can be extended easily with appropriate modifications to other applications.

What is claimed is:

1. A device for wireless communication comprising:
a wireless local area network (WLAN) module to establish a peer-to-peer network connection with a client and a Bluetooth module to establish a Bluetooth communication link, wherein:
the device further to determine parameters regarding an activity of the Bluetooth communication link and to transmit a beacon frame to the client having a notice of absence (NoA) information element (IE);
the parameters including a start instant, a window and a Bluetooth interval;
the NoA IE including a start time that corresponds to an advanced audio distribution profile (A2DP) instant of the Bluetooth communication link, an absence duration that corresponds to the window and a NoA interval that corresponds to the Bluetooth interval.

2. The device of claim 1, wherein the device further to protect the Bluetooth communication link prior to transmitting the beacon frame by sending to the client a clear to send to self (CTS2S) frame.

3. The device of claim 1, wherein the device further to:
determine if the Bluetooth communication link will exceed the window; and
if the Bluetooth communication link will exceed the Bluetooth, send a clear to send to self (CTS2S) frame to extend the absence duration.

4. The device of claim 1, wherein the device further to:
determine if the Bluetooth communication link has been disconnected; and
transmit a beacon frame including a discontinuing NoA IE if determined that the Bluetooth communication link has been disconnected.

5. The device of claim 1, wherein the device further to monitor Bluetooth activity to determine if transmission timing adjustments are to be implemented to protect Bluetooth communications.

6. The device of claim 1, wherein the Bluetooth communication link to operate in an asynchronous mode of activity.

7. In a wireless communications system comprising a wireless local area network (WLAN) module to establish a peer-to-peer network connection with a client and a Bluetooth module to establish a Bluetooth communication link, a method of providing co-existence by preventing signal interference therebetween, the method comprising:
transmitting a beacon frame to the client, the beacon frame including a notice of absence (NoA) information element (IE) that includes a start time that corresponds to a start instant of a Bluetooth communication link with the client, an absence duration that corresponds to a window of the Bluetooth communication link and a NoA interval that corresponds to a Bluetooth interval of the Bluetooth communication link.

8. The method of claim 7, further comprising sending to the client a clear to send to self (CTS2S) frame prior to transmitting the beacon frame.

9. The method of claim 7, further comprising determining if the Bluetooth communication link will exceed the Bluetooth window; and
if the Bluetooth communication link will exceed the window, sending to said client a clear to send to self (CTS2S) frame to extend the absence duration a corresponding period of time.

10. The method of claim 7, further comprising transmitting frame having a discontinuing NoA information element after determining that the Bluetooth communication link has been disconnected.

11. The method of claim 7, further comprising monitoring Bluetooth activity to determine if transmission timing adjustments are to be implemented to protect the Bluetooth communication link.

12. The method of claim 11, further comprising adjusting the NoA schedule based, at least in part, on Bluetooth activity monitoring.

13. The method of claim 7, further comprising:
assigning default duty cycle parameters to initiate time sharing and setting NoA parameters based on default WLAN-Bluetooth time sharing parameters;
after NoA periodic schedule starts, monitoring Bluetooth traffic during the window;
adding time to the window if traffic on the Bluetooth communication link is above a predetermined threshold; and
if time is added to the window, dynamically changing NoA parameters to conform to the window.

14. The method of claim 13, further comprising periodically determining if time is to be added to or removed from the window a first period of time after each increase in the window and a second period of time after each decrease in the window, where the first period of time is shorter than the second period of time.

15. The method of claim 14, wherein the first period of time is less than half of the second period of time.

16. The method of claim 14, further comprising, if time is added to or removed from the window after the first period of time, applying new NoA parameters to comport with the window.

17. A non-transitory process-readable storage medium for providing coexistence in a wireless communications device including a wireless local area network (WLAN) module to establish a peer-to-peer network connection with a client and a Bluetooth module to establish a Bluetooth communication link, the processor-readable storage medium including instructions thereon, when executed by a processor, to cause the wireless communications device to:
transmit a beacon frame to the client, the beacon frame including a notice of absence (NoA) information element (IE), wherein:
parameters regarding an activity of the Bluetooth communication link includes a start instant, a window and a Bluetooth interval, and the NoA IE includes a start time that corresponds to the start instant of the Bluetooth communication link, an absence duration that corresponds to the window of the Bluetooth communication link and a NoA interval that corresponds to the Bluetooth interval.

18. The storage medium of claim 17, further including instructions thereon, when executed by a processor, to cause the wireless communications device to:
protect the Bluetooth communication link prior to transmitting the beacon frame by sending to the client a Clear to Send to Self (CTS2S) frame.

19. The storage medium of claim 17, further including instructions thereon, when executed by a processor, to cause the wireless communications device to:
determine if the Bluetooth communication link will exceed the window; and
if the Bluetooth communication link will exceed the window, send a Clear to Send to Self (CTS2S) frame to the client to extend the absence duration.

20. The storage medium of claim 17, further including instructions thereon, when executed by a processor, to cause the wireless communications device to:
transmit a beacon frame including a discontinuing NoA IE if determined that the Bluetooth communication link has been discontinued.
